(19) United States
(12) Patent Application Publication
(10) Pub. No.: US 2025/0090941 A1
(43) Pub. Date: Mar. 20, 2025

(54) CLAW MACHINE

(71) Applicant: PAOKAI ELECTRONIC ENTERPRISE CO., LTD., Kaohsiung City (TW)

(72) Inventor: Ming-Shan WEI, Kaohsiung City (TW)

(21) Appl. No.: 18/442,397

(22) Filed: Feb. 15, 2024

(30) Foreign Application Priority Data
Sep. 19, 2023 (TW) 112135685

(51) Int. Cl. A63F 9/30; G07F 17/32

(52) U.S. Cl. CPC A63F 9/30; G07F 17/3216; G07F 17/3246; G07F 17/3297; A63F 2250/142

(57) ABSTRACT

A claw machine includes a machine body, a setting module, a claw, and a control device. The machine body includes a base having a prize outlet passage, and a cabinet defining an inner space that has a start zone and a game field. The setting module includes at least one divider that partitions the game field into multiple game compartments. The control device includes a coin module, an operating interface, and a processing unit. The processing unit, upon receiving a start signal from the coin module, controls the claw to move through all of the game compartments one by one. In each game compartment, a player attempts to grab a prize by maneuvering the claw and by pressing a grab button. After each attempt, the claw is moved above the prize outlet passage to open, and is moved to a next game compartment or returns to the start zone.

### CROSS-REFERENCE TO RELATED APPLICATION

This application claims priority to Taiwanese Invention Patent Application No. 112135685, filed on Sep. 19, 2023, the entire disclosure of which is incorporated by reference herein.

### FIELD

The disclosure relates to an entertainment machine, and more particularly to a claw machine.

### BACKGROUND

A conventional claw machine generally allows a player to have only one chance to move a claw to a desired location (usually above a desired prize) within a cabinet of the conventional claw machine, and to make a prize grabbing attempt, when a coin or a token is inserted into a coin slot of the conventional claw machine. Therefore, a gameplay of the conventional claw machine is fixed, and ways to attract players to play the conventional claw machine are usually through modifying a layout of the cabinet or changing prizes that are placed in the cabinet. However, modifying the layout of the cabinet only attracts players at the beginning, and changing the prizes may attract a player if the player thinks he or she has a certain chance of grabbing the prizes. If players do not have a pleasant experience while playing the conventional claw machine, the conventional claw machine may not be able to attract the players to play for a longer period of time.

### SUMMARY

Therefore, an object of the disclosure is to provide a claw machine that can alleviate at least one of the drawbacks of the prior art.

According to the disclosure, the claw machine includes a machine body, a setting module, a claw and a control device.

The machine body includes a base that has a prize outlet passage, and a cabinet that is disposed on and above the base. The cabinet defines an inner space in spatial communication with the prize outlet passage. The inner space has a start zone and a game field.

The setting module is disposed in the game field of the inner space, and includes at least one divider that partitions the game field of the inner space into a plurality of game compartments. The game compartments are in spatial communication with the prize outlet passage.

The claw is disposed in the inner space, and is movable within the inner space.

The control device is disposed on the machine body, and includes a coin module that has a coin slot. The coin module is configured to generate a start signal upon detecting a coin put into the coin slot. The control device further includes an operating interface that is operable to move the claw, and to generate a grab signal for making the claw to perform a grabbing action.

The control device further includes a processing unit that is electrically connected to the coin module and the operating interface. The processing unit is configured to, upon receiving the start signal from the coin module, control the claw to move from the start zone to one of the game compartments; when the claw is in one of the game compartments, the processing unit is further configured to allow the claw to move, by operating the operating interface, only within the one of the game compartments; upon receiving the grab signal, the processing unit is further configured to control the claw to perform the grabbing action; and after the grabbing action is completed, the processing unit is further configured to control the claw sequentially to move to a position above the prize outlet passage, to open, and then to move to one of the start zone and another one of the game compartments.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a perspective view of a claw machine according to an embodiment of the present disclosure.

FIG. 2 is a top view of a machine body of the claw machine according to an embodiment of the present disclosure.

FIG. 3 is a block diagram of the claw machine according to an embodiment of the present disclosure.

FIG. 4 is a top view of the machine body, illustrating a claw in one of a plurality of game compartments according to an embodiment of the present disclosure.

FIG. 5 is a top view of the machine body, illustrating the claw in another one of the game compartments according to an embodiment of the present disclosure.

FIG. 6 is a top view of the machine body, illustrating the claw in a bonus compartment according to an embodiment of the present disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

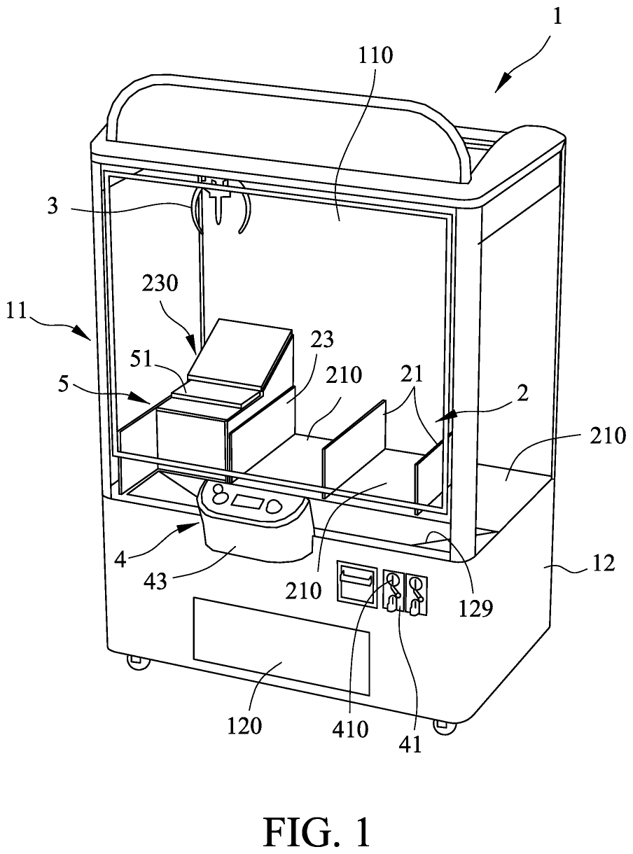

Referring to FIG. 1, a claw machine according to an embodiment of this disclosure includes a machine body 1, a setting module 2, a claw 3, a control device 4, and a bonus gaming module 5.

Referring to FIGS. 1 to 3, the machine body 1 includes a base 12 that has a prize outlet passage 120, and a cabinet 11 that is disposed on and above the base 12. The cabinet 11 defines an inner space 110 that is in spatial communication with the prize outlet passage 120. The inner space 110 has a start zone 111 and a game field 112. In this embodiment, a layout of the inner space 110 may be arranged by an owner of the claw machine for allowing a player to play a game by moving the claw 3. The game field 112 is adapted to be placed with a plurality of prizes. The base 12 is provided for hardware components of the control device 4 to be disposed thereon, and is generally disposed below the cabinet 11 as shown in FIG. 1. It should be noted that the structural configuration of the machine body 1 is not limited to the above-mentioned example.

The setting module 2 is disposed in the game field 112 of the inner space 110, and includes at least one divider 21 that partitions the game field 112 into a plurality of game compartments 210 each being placed with a plurality of prizes. In this embodiment, the setting module 2 includes two dividers 21 that partition the game field 112 into three game compartments 210. The game compartments 210 are in spatial communication with the prize outlet passage 120. It should be noted that a number of the dividers 21 is not limited to two.

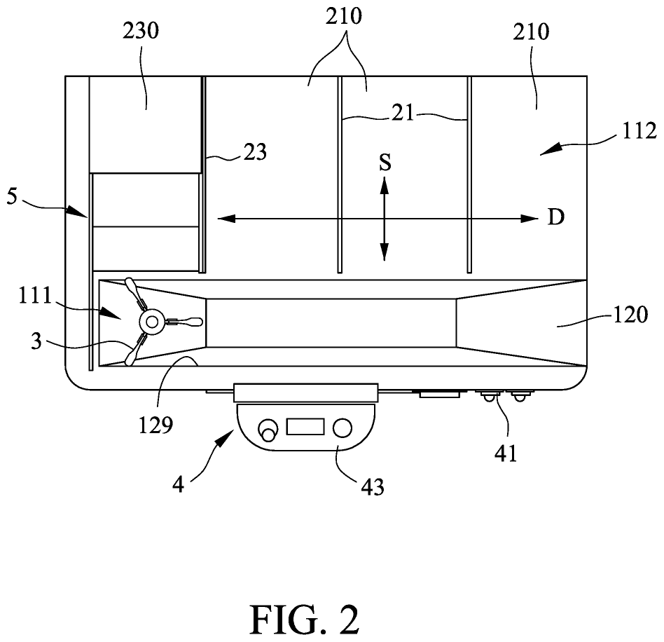

The setting module 2 further includes a separator 23 that defines a bonus compartment 230. The bonus compartment 230 is within the game field 112 of the inner space 110, and is outside of the game compartments 210. That is to say, the game field 112 is partitioned into three game compartments 210 and one bonus compartment 230 by the dividers 21 and the separator 23. The bonus compartment 230 is also in spatial communication with the prize outlet passage 120. The game compartments 210 are arranged along a first direction (D), and the bonus compartment 230 is adjacent to one of the game compartments 210 (i.e., the left one as shown in FIGS. 1 and 2) along the first direction (D). The prize outlet passage 120 is located on one side of the game field 112 along a second direction (S) that is perpendicular to the first direction (D). The prize outlet passage 120 has an upper end that is adjacent to the game field 112 along the second direction (S), and that is formed with an opening 129, which allows a prize that is successfully grabbed from any one of the game compartments 210 and the bonus compartment 230 to be delivered to a player. Each of the dividers 21 and the separator 23 may be a divider board in order to clearly define the game compartments 210 and the bonus compartment 230.

The setting module 2 further includes a plurality of position sensors 22. Each one of the position sensors 22 is placed at a border between two of the game compartments 210 that are adjacent to each other. In this embodiment, a number of the game compartments 210 is three, and thus there are two borders. Therefore, two position sensors 22 are placed at the two borders, respectively. The position sensors 22 are electrically connected to the control device 4. The position sensors 22 are configured to detect a position of the claw 3, and to generate and send, to the control device 4, a position signal indicating which one of the game compartments 210 the claw 3 is currently located in. For example, the position sensors 22 may be optical sensors such as infrared sensors. In this embodiment, when the claw 3 is controlled by the control device 4 to move across one of the borders along the first direction (D), the corresponding one of the position sensors 22 may be triggered, upon detecting the claw 3, to generate and send a position signal to the control device 4. The position signal provides the control device 4 with information indicating that the claw 3 is at one of the game compartments 210 that is adjacent to the one of the borders at which the corresponding one of the position sensors 22 is triggered.

The claw 3 is disposed in the inner space 110, and is movable within the inner space 110. The claw 3 is operable to move between the start zone 111 and the game field 112. The start zone 111 is above the opening 129 of the prize outlet passage 120. The start zone 111 is defined as a default location where the claw 3 is controlled to return before a play (i.e., before a coin is inserted into the claw machine) and after the play. For example, the start zone 111 is a lower left corner of the inner space 110 as shown in FIG. 2.

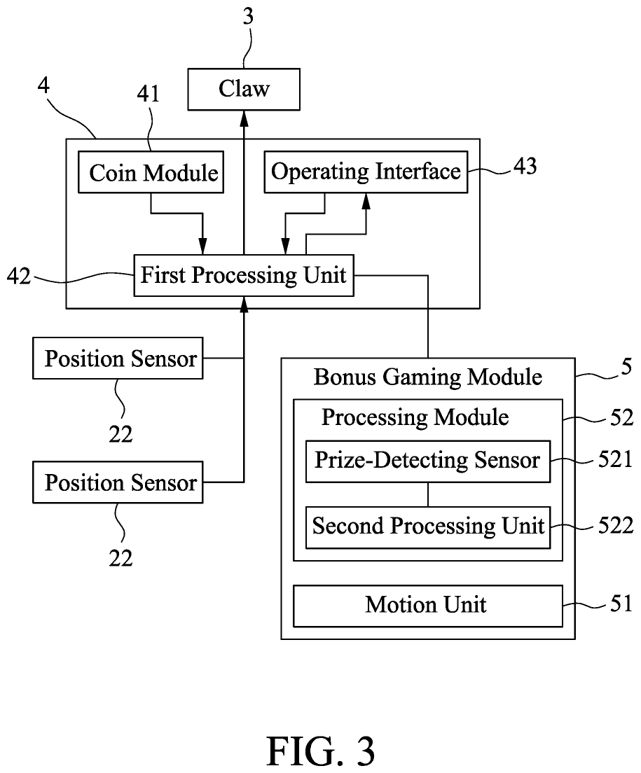

Referring to FIGS. 1 and 3, the control device 4 is disposed on the machine body 1. In this embodiment, the control device 4 is disposed at a front side of the machine body 1 on the base 12. The control device 4 includes a coin module 41 that has a coin slot 410 and that is configured to generate a start signal upon detecting a coin put into the coin slot 410, and an operating interface 43 that is operable by a player to move the claw 3 and to generate a grab signal for making the claw 3 perform a grabbing action (i.e., the claw 3 descends from an original height to a predetermined height (generally close to an inner bottom surface of the cabinet 11) in an open state, then closes for grabbing a prize, and rises back to the original height). The operating interface 43 generally includes a joystick (or a set of arrow buttons) that allows a player to control the claw 3 to move back, forth and sideways, and a grab button that generates the grab signal for making the claw 3 to perform the grabbing action when being pressed by a player.

Referring to FIGS. 2 and 3, the control device 4 further includes a first processing unit 42 that is electrically connected to the position sensors 22, the coin module 41 and the operating interface 43. When the dividers 21 and the separator 23 have been placed on the game field 112, the first processing unit 42 may be programmed to store information of locations respectively of the dividers 21 and a location of the separator 23. With the information of the locations of the dividers 21 and the location of the separator 23, and the position signal corresponding to the position of the claw 3, the first processing unit 42 is able to know which of the game compartments 210 the claw 3 is currently located in. In specific, the first processing unit 42 may use the information of the locations of the dividers 21 and the location of the separator 23 to map out an area and a range of each of the game compartments 210 and the bonus compartment 230 within the game field 112. The first processing unit 42 may then control or limit a movement of the claw 3 within a specific area (e.g., one of the game compartments 210) of the game field 112. For example, the first processing unit 42 may calculate, based on the ranges of the game compartments 210, movable distances of the claw 3 respectively along the first direction (D) and along the second direction (S) for each one of the game compartments 210. For each of the game compartments 210, the first processing unit 42 may then control or limit the movement of the claw 3 when the claw 3 is at the game compartment 210, based on the movable distances that correspond to the game compartment 210. A way of controlling or limiting the movement of the claw 3 may involve controlling rotation angles of respective motors that drive the claw 3 to slide along slide rails in both the first direction (D) and the second direction (S). In other embodiments, an optical sensing mechanism (e.g., infrared sensors) may be used to provide the information of the locations of the dividers 21 and the location of the separator 23. For example, the first processing unit 42 may include, but is not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc. for executing a programmed game logic for playing a game based on inputs from a number of the components of the claw machine, such as the operating interface 43 and the position sensors 22.

The first processing unit 42 is configured to control the claw 3 to move from the start zone 111 to one of the game compartments 210 upon receiving the start signal from the coin module 41. When the claw 3 is in one of the game compartments 210, the first processing unit 42 is configured to allow the claw 3 to move, by operating the operating interface 43, only within the one of the game compartments 210; that is to say, a player can operate the operating interface 43 to move the claw 3 within the one of the game compartments 210. In specific, if the player operates the operating interface 43 to control the claw 3 to move along the first direction (D) toward one of the borders, and the position sensor 22 that corresponds to the one of the borders detects the claw 3, the position sensor 22 may generate and send a position signal to the first processing unit 42. Upon receiving the position signal, the first processing unit 42 may stop the claw 3 from moving further along the first direction (D) toward the one of the borders, preventing the claw 3 from moving across the one of the borders. The first processing unit 42, upon receiving the grab signal, then controls the claw 3 to perform the grabbing action. After the grabbing action is completed, the first processing unit 42 controls the claw 3 sequentially to move to a position above the prize outlet passage 120, to open, and then to move to the start zone 111 or to another one of the game compartments 210.

Referring to FIGS. 1, 3 and 6, the bonus gaming module 5 is disposed in the bonus compartment 230. The bonus gaming module 5 is electrically connected to the first processing unit 42, and is configured to be controlled by the first processing unit 42 to perform a bonus game for a bonus prize. Specifically, when the claw 3 is in one of the game compartments 210 that is adjacent to the bonus compartment 230 and the grabbing action is completed, the first processing unit 42 controls the claw 3 sequentially to move to the bonus compartment 230, to open, and then to move back to the start zone 111. The bonus gaming module 5 provides different gameplay experiences to the player other than just allowing the player to operate the claw 3 to grab only one prize in the inner space 110.

The bonus gaming module 5 includes a motion unit 51 that is configured to be controlled by the first processing unit 42 to operate in the bonus game. The bonus gaming module 5 further includes a processing module 52 that is connected to the motion unit 51. The processing module 52 includes a second processing unit 522 and a prize-detecting sensor 521 that is electrically connected to the second processing unit 522. For example, the second processing unit 522 may include, but is not limited to, a single core processor, a multi-core processor, a dual-core mobile processor, a microprocessor, a microcontroller, a digital signal processor (DSP), a field-programmable gate array (FPGA), an application specific integrated circuit (ASIC), and/or a radio-frequency integrated circuit (RFIC), etc. In this embodiment, the motion unit 51 is a mechanism similar to a coin pusher. The prize-detecting sensor 521 is disposed on a surface of the motion unit 51, and is configured to detect whether the motion unit 51 successfully pushes a prize into the prize outlet passage 120 and to transmit a signal to the second processing unit 522 when detecting that the motion unit 51 successfully pushes a prize into the prize outlet passage 120. If the second processing unit 522 determines that the motion unit 51 has successfully pushed a prize into the prize outlet passage 120 based on the signal from the prize-detecting sensor 521, a play ends. Else, if the second processing unit 522 determines that the motion unit 51 has not successfully pushed a prize into the prize outlet passage 120 (i.e., not receiving the signal from the prize-detecting sensor 521), the second processing unit 522 sends a retry signal to the first processing unit 42. Upon receiving the retry signal, the first processing unit 42 controls the claw 3 to move to the game compartment 210 that is adjacent to the bonus compartment 230, and allows the player to operate the operating interface 43 to move the claw 3 within the game compartment 210 to try grabbing a prize again. When the grabbing action is completed, the first processing unit 42 controls the claw 3 sequentially to move to the bonus compartment 230, to open, and then to move back to the start zone 111. The second processing unit 522 may send the retry signal to the first processing unit 42 again if the second processing unit 522 determines that the motion unit 51 has not successfully pushed a prize into the prize outlet passage 120 for a second time. The above-mentioned operations may be repeated until the second processing unit 522 determines that the motion unit 51 has successfully pushed a prize into the prize outlet passage 120, and the play ends.

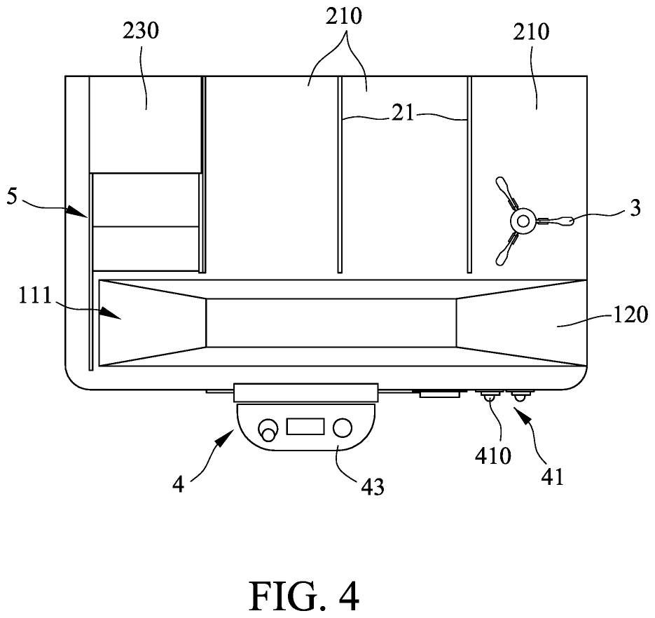

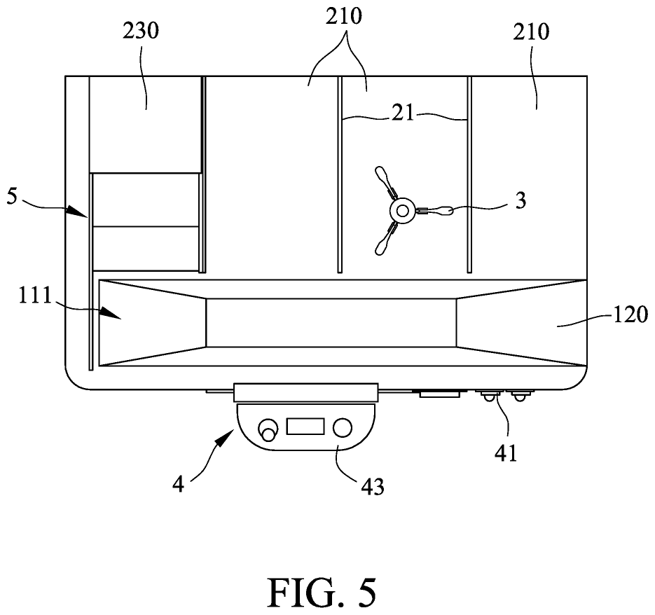

Referring to FIGS. 3 to 5, when the player inserts a coin into the coin slot 410, the coin module 41 generates the start signal and sends the start signal to the first processing unit 42. When the first processing unit 42 receives the start signal from the coin module 41, the first processing unit 42 controls the claw 3 to move from the start zone 111 to one of the game compartments 210 (as shown in FIG. 4, hereinafter referred to as a “first game compartment 210”). When the claw 3 is in the first game compartment 210, the first processing unit 42 executes a play mode, allowing the player to operate the operating interface 43 for moving the claw 3 only within the first game compartment 210. In the play mode, the player may operate the operating interface 43 to maneuver the claw 3 within the first game compartment 210. When the player has maneuvered the claw 3 to a desired location (generally above a target prize), the player may press the grab button. When the grab button is pressed, the operating interface 43 generates and sends the grab signal to the first processing unit 42. Upon receiving the grab signal, the first processing unit 42 controls the claw 3 to perform the grabbing action and the play mode is finished. After the grabbing action is completed, the first processing unit 42 executes a transition mode to control the claw 3 sequentially to move to a position above the prize outlet passage 120, to open, and then to move to another one of the game compartments 210 (as shown in FIG. 5, hereinafter referred to as a “second game compartment 210”) or to the bonus compartment 230. When the claw 3 opens, and should the target prize has been successfully grabbed, the target prize is dropped into the prize outlet passage 120. In the transition mode, the first processing unit 42 controls the claw 3 to move to one of those of the game compartments 210 in which the first processing unit 42 has not executed the play mode, and controls the claw 3 to move to the bonus compartment 230 when the first processing unit 42 has executed the play mode in all of the game compartments 210.

In this embodiment, the first processing unit 42 in the transition mode controls the claw 3 to move to a position above the prize outlet passage 120, and then controls the claw 3 to open regardless of whether the target prize has been successfully grabbed. In other embodiments, a sensor electrically connected to the first processing unit 42 may be used to detect whether the claw 3 successfully grabs a prize in the play mode, and the first processing unit 42 in the transition mode controls the claw 3 to move to a position above the prize outlet passage 120 and to open only when the first processing unit 42 determines that the claw 3 grabs a prize. Otherwise, the first processing unit 42 in the transition mode controls the claw 3 to directly move to the second game compartment 210 after the grabbing action is completed without moving the claw 3 to a position above the prize outlet passage 120.

When the claw 3 is in the second game compartment 210, the first processing unit 42 executes the play mode again to allow the player to operate the operating interface 43 within the second game compartment 210 and to press the grab button for another grabbing action. In this embodiment, the number of the game compartments 210 is three, and hence, the player is able to operate the operating interface 43 three times, making three prize grabbing attempts; that is to say, the first processing unit 42 executes the play mode three times respectively in the game compartments 210. It should be noted that in other embodiments where the number of the game compartments 210 is more than three, the first processing unit 42 may continue to execute the play mode to control the claw 3 to move to another one of the game compartments 210 after controlling the claw 3 sequentially to move to a position above the prize outlet passage 120 to open, so long as there is still another one of the game compartments 210 that the player has not played.

It should be noted that, in order to provide the player with different gameplay experiences, the first processing unit 42 may be further configured to adjust a gaming parameter related to the grabbing action according to the position of the claw 3 that is indicated by the position signal. The gaming parameter has a plurality of values corresponding respectively to the game compartments 210. In this embodiment, the gaming parameter is a gripping force of the claw 3. With different values of the gaming parameter for the game compartments 210, the gripping force of the claw 3 has a different value when the claw 3 is in each of the game compartments 210. Hence, a level of difficulty of grabbing a prize may be different in each of the game compartments 210. The gaming parameter may also be a time limit for the player to operate the operating interface 43, a movement speed of the claw 3, or etc., so long as the gaming parameter is related to the level of difficulty of grabbing a prize, and is not limited to the above-mentioned examples.

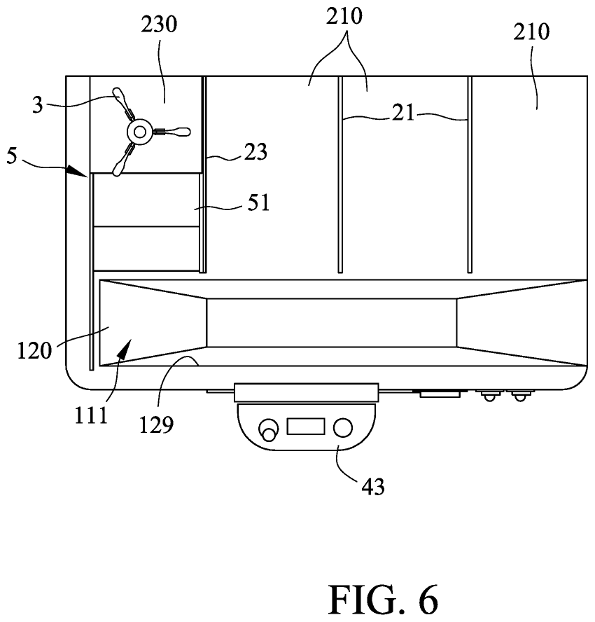

When the claw 3 is in one of the game compartments 210 that is adjacent to the bonus compartment 230 (i.e., the left one and referred to as a “last game compartment 210” hereinafter) and the first processing unit 42 receives the grab signal, the first processing unit 42 controls the claw 3 to perform the grabbing action and then performs the bonus game. After the grabbing action is completed, the first processing unit 42 controls the claw 3 sequentially to move to the bonus compartment 230 as shown in FIG. 6, to open, and then to move back to the start zone 111. The bonus gaming module 5 may use the prize grabbed from the last game compartment 210, and based on the operation of the motion unit 51, the processing module 52 determines whether to give the bonus prize. In this embodiment, the motion unit 51 is configured to push the prize grabbed from the last game compartment 210 into the prize outlet passage 120, and the bonus prize is a guaranteed prize grabbed from the last game compartment 210. That is to say, if a player failed to grab a prize during the play mode in the last game compartment 210, the player may play in the play mode to try grabbing a prize in the last game compartment 210 repeatedly until the player successfully grabs a prize and the prize is successfully pushed into the prize outlet passage 120 by the motion unit 51. Aside from just the prize grabbing attempts in the game compartments 210, the bonus gaming module 5 provides the different gameplay experiences, for example, the bonus gaming module 5 uses the prize grabbed from the last game compartment 210 to play the bonus game, operation of the motion unit 51 produces different outcomes during the bonus game, and the player has a chance to win the bonus prize.

Accordingly, upon putting a coin in the coin slot 410 one time, the player is able to not only make the prize grabbing attempts three times respectively in the three game compartments 210, but also play the bonus game in the bonus compartment 230. The claw machine according to the embodiment of this disclosure is not only able to attract the player through multiple times of the prize grabbing attempts, but also able to provide the different gameplay experiences for the one-time coin insertion.

It should be noted that, in other embodiments, the separator 23 may be omitted, and thereby the game field 112 has only the game compartments 210 that are arranged along the first direction (D) without the bonus compartment 230. In this case, the first processing unit 42 controls the claw 3 to move to all the game compartments 210 one by one, and the first processing unit 42 executes the play mode in each of the game compartments 210. When the claw 3 is at a last one of the game compartments 210, the first processing unit 42 controls the claw 3 sequentially to move to a position above the prize outlet passage 120, to open, and then to move to the start zone 111 after the grabbing action is completed.

To sum up, the claw machine of this disclosure enables the player to start playing upon inserting a coin into the coin slot 410. The player is then able to play multiple times (one time in one of the game compartments 210) by operating the operating interface 43 to make the prize grabbing attempts. Furthermore, the player is able to acquire the different gameplay experience, i.e., the bonus game in the bonus compartment 230. With the different values of the gaming parameter, the player is able to experience the different levels of difficulty of grabbing a prize. Different kinds of prizes may be placed in the game field 112. The bonus gaming module 5 may also be used flexibly to provide the different gameplay experience. With all the foregoing elements that are adjustable, the claw machine of this disclosure may provide a variety of ways to set up the claw machine, and therefore, is able to achieve the objective of this disclosure.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is (are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A claw machine comprising:
a machine body including a base that has a prize outlet passage, and a cabinet that is disposed on and above said base and that defines an inner space in spatial communication with the prize outlet passage, the inner space having a start zone and a game field;
a setting module disposed in the game field of the inner space, and including at least one divider that partitions the game field of the inner space into a plurality of game compartments, the game compartments being in spatial communication with the prize outlet passage;
a claw disposed in the inner space, and movable within the inner space; and
a control device disposed on said machine body, and including a coin module that has a coin slot and that is configured to generate a start signal upon detecting a coin put into the coin slot, an operating interface that is operable to move said claw and to generate a grab signal for making said claw to perform a grabbing action, and a processing unit that is electrically connected to said coin module and said operating interface, said processing unit being configured to
upon receiving the start signal from said coin module, control said claw to move from the start zone to one of the game compartments,
when said claw is in one of the game compartments, allow said claw to move, by operating said operating interface, only within the one of the game compartments,
upon receiving the grab signal, control said claw to perform the grabbing action, and
after the grabbing action is completed, control said claw sequentially to move to a position above the prize outlet passage, to open, and then to move to one of the start zone and another one of the game compartments.

2. The claw machine as claimed in claim 1, wherein said setting module further includes a plurality of position sensors that are electrically connected to said processing unit, and that are configured to detect a position of said claw and to send, to said processing unit, a position signal indicating which one of the game compartments said claw is currently located in, and
wherein said processing unit is further configured to adjust a gaming parameter related to the grabbing action according to the one of the game compartments indicated by the position signal, and the gaming parameter has a plurality of values corresponding respectively to the game compartments.

3. The claw machine as claimed in claim 2, wherein the gaming parameter is a gripping force of said claw.

4. The claw machine as claimed in claim 3, wherein the game compartments are arranged along a first direction.

5. The claw machine as claimed in claim 4, wherein the prize outlet passage is located on one side of the game field along a second direction that is perpendicular to the first direction, and has an upper end that is adjacent to the game field along the second direction and that is formed with an opening.

6. The claw machine as claimed in claim 2, wherein the game compartments are arranged along a first direction.

7. The claw machine as claimed in claim 6, wherein the prize outlet passage is located on one side of the game field along a second direction that is perpendicular to the first direction, and has an upper end that is adjacent to the game field along the second direction and that is formed with an opening.

8. The claw machine as claimed in claim 1, wherein the game compartments are arranged along a first direction.

9. The claw machine as claimed in claim 8, wherein the prize outlet passage is located on one side of the game field along a second direction that is perpendicular to the first direction, and has an upper end that is adjacent to the game field along the second direction and that is formed with an opening.

10. The claw machine as claimed in claim 1, wherein said setting module further includes a separator defining a bonus compartment that is within the game field of the inner space and that is outside of the game compartments,
wherein said claw machine further comprises a bonus gaming module that is disposed in the bonus compartment, that is electrically connected to said processing unit, and that is configured to be controlled by said processing unit to perform a bonus game for a bonus prize, and
wherein when said claw is in one of the game compartments that is adjacent to the bonus compartment, said processing unit is further configured to
control said claw to perform the grabbing action upon receiving the grab signal, and
after the grabbing action is completed, control said claw sequentially to move to the bonus compartment, to open, and then to move back to the start zone.

11. The claw machine as claimed in claim 10, wherein said bonus gaming module includes a motion unit that is configured to be controlled by said processing unit to operate in the bonus game.

12. The claw machine as claimed in claim 11, wherein said bonus gaming module further includes a processing module that is connected to said motion unit, and that is configured to determine whether to output the bonus prize based on operation of said motion unit.

13. The claw machine as claimed in claim 12, wherein the game compartments are arranged along a first direction, and the bonus compartment is adjacent to one of the game compartments along the first direction.

14. The claw machine as claimed in claim 13, wherein the prize outlet passage is located on one side of the game field along a second direction that is perpendicular to the first direction, and has an upper end that is adjacent to the game field along the second direction and that is formed with an opening.

15. The claw machine as claimed in claim 11, wherein the game compartments are arranged along a first direction, and the bonus compartment is adjacent to one of the game compartments along the first direction.

16. The claw machine as claimed in claim 15, wherein the prize outlet passage is located on one side of the game field along a second direction that is perpendicular to the first direction, and has an upper end that is adjacent to the game field along the second direction and that is formed with an opening.

17. The claw machine as claimed in claim 10, wherein the game compartments are arranged along a first direction, and the bonus compartment is adjacent to one of the game compartments along the first direction.

18. The claw machine as claimed in claim 17, wherein the prize outlet passage is located on one side of the game field along a second direction that is perpendicular to the first direction, and has an upper end that is adjacent to the game field along the second direction and that is formed with an opening.
